(19) United States
(12) Patent Application Publication
(10) Pub. No.: US 2018/0077717 A1
(43) Pub. Date: Mar. 15, 2018

(54) CELLULAR SCHEDULER APPARATUS, COMPUTER PROGRAM, AND METHOD FOR SELECTING USER EQUIPMENT BASED ON BEAM OR DELAY STATE INFORMATION

(71) Applicant: Futurewei Technologies, Inc., Plano, TX (US)

(72) Inventors: Cornelius Dawid Janse van Rensburg, Wylie, TX (US); Yiping Mao, Dallas, TX (US)

(21) Appl. No.: 15/261,689

(22) Filed: Sep. 9, 2016

(51) Int. Cl. H04W 72/12; H04B 7/06

(52) U.S. Cl. CPC H04W 72/1231; H04W 72/1247; H04B 7/0617

(57) ABSTRACT

A cellular scheduler apparatus, computer program, and method are provided for selecting user equipment based on beam or delay state information. State information is stored utilizing at least one data structure of a base station. Such at least one data structure includes, at the least, a beam data structure for storing beam state information, and/or a delay data structure for storing delay state information. At least one of the beam state information or the delay state information is received at the base station scheduler. Further, the base station scheduler is utilized to generate a communication schedule for communications between the base station and a plurality of user equipment, based on at least one of the beam state information or the delay state information. Still yet, at least one of the user equipment is selected, based on the communication schedule.

### FIELD OF THE INVENTION

The present invention relates to cellular communication systems, and more particularly to cellular schedulers.

### BACKGROUND

In today's cellular systems, downlink performance is becoming increasingly important with the emergence of downlink-bandwidth intensive applications. For example, efforts are being deployed to provide good user throughput in most of a coverage area. One challenge in those efforts involves setting a power and other parameters of data communications in a way that allows optimal network utilization. For example, if one particular node communicates with a power that exceeds its needs and does more harm than good (with respect to network usage by an adjacent node), network utilization is not optimized.

### SUMMARY

A cellular scheduler apparatus, computer program, and method are provided for selecting user equipment (UE) based on beam or delay state information. State information is stored utilizing at least one data structure of a base station. Such at least one data structure includes, at the least, a beam data structure for storing beam state information, and/or a delay data structure for storing delay state information. At least one of the beam state information or the delay state information is received at the base station scheduler. Further, the base station scheduler is utilized to generate a communication schedule for communications between the base station and a plurality of user equipment, based on at least one of the beam state information or the delay state information. Still yet, at least one of the user equipment is selected, based on the communication schedule.

In a first embodiment, the state information may be communicated from the at least one data structure to the scheduler of the base station, via another scheduler. As an option, the scheduler may include a physical scheduler, and the another scheduler may include a virtual scheduler. As another option, the state information may be updated utilizing the another scheduler, based on one or more constraints.

In a second embodiment (which may or may not be combined with the first embodiment), the state information may further include power state information stored utilizing a power data structure. Thus, as an option, the at least one UE may be selected based on the power state information, utilizing the scheduler of the base station, for controlling a power expended by the base station.

In a third embodiment (which may or may not be combined with the first and/or second embodiments), the at least one data structure may include the beam data structure, such that at least one UE is selected based on the beam state information, utilizing the scheduler of the base station, for controlling a flashlight effect in connection with the base station.

In a fourth embodiment (which may or may not be combined with the first, second, and/or third embodiments), the at least one data structure may include the delay data structure, such that at least one UE is selected based on the delay state information, utilizing the scheduler of the base station, for controlling a delay in connection with a communication between the base station and the at least one UE.

In a fifth embodiment (which may or may not be combined with the first, second, third and/or fourth embodiments), a difference in a flashlight effect between a plurality of instances of the selecting, may be computed. Further, at least one of the instances of the selecting may be based on the computed difference in the flashlight effect.

In a sixth embodiment (which may or may not be combined with the first, second, third, fourth and/or fifth embodiments), the selection of the at least one UE may conditionally occur based a cost associated with the state information. Further, the UE may be selected if the cost associated with the state information results in a positive network utility. Further, at least one virtual user may be selected if the cost associated with the state information results in a negative network utility.

In a seventh embodiment (which may or may not be combined with the first, second, third, fourth and/or sixth embodiments), the base station scheduler further generates the communication schedule based on at least one of a call priority, a call timing, a call location, or a call quality of service rating.

To this end, in some optional embodiments, one or more of the foregoing features of the aforementioned apparatus, computer program, and/or method may allow a scheduler to take various parameters (e.g. power-, beam-, delay-, etc. related parameters) into account when selecting a particular UE to service. This may, in turn, result in more granular network utilization optimization across a more thorough set of parameters that would otherwise be foregone in systems that lack such capabilities. It should be noted that the aforementioned potential advantages are set forth for illustrative purposes only and should not be construed as limiting in any manner.

### BRIEF DESCRIPTION OF THE DRAWINGS

FIG. 1 illustrates a method for selecting user equipment (UE) based on beam or delay state information, in accordance with one embodiment.

FIG. 2 illustrates a system for selecting a UE based on state information, in accordance with one embodiment.

FIG. 3A illustrates a base station scenario including two base stations facing each other each serving two users, in accordance with one embodiment.

FIG. 3B illustrates a base station scenario including two base stations facing each other and serving three users, in accordance with one embodiment.

FIG. 4 illustrates a plot showing utility progression over time, in accordance with one embodiment.

FIG. 5 illustrates a plot showing utility progression over time, in accordance with one embodiment.

FIG. 6 illustrates a plot showing utility progression over time, in accordance with one embodiment.

FIG. 7 illustrates a plot showing utility progression over time, in accordance with one embodiment.

FIG. 8 illustrates a plot showing utility progression over time, in accordance with one embodiment.

FIG. 9 illustrates a plot showing utility progression over time, in accordance with one embodiment.

FIG. 10 illustrates a plot showing utility progression over time, in accordance with one embodiment.

FIG. 11 illustrates a network architecture, in accordance with one embodiment.

FIG. 12 illustrates an exemplary system, in accordance with one embodiment.

### DETAILED DESCRIPTION

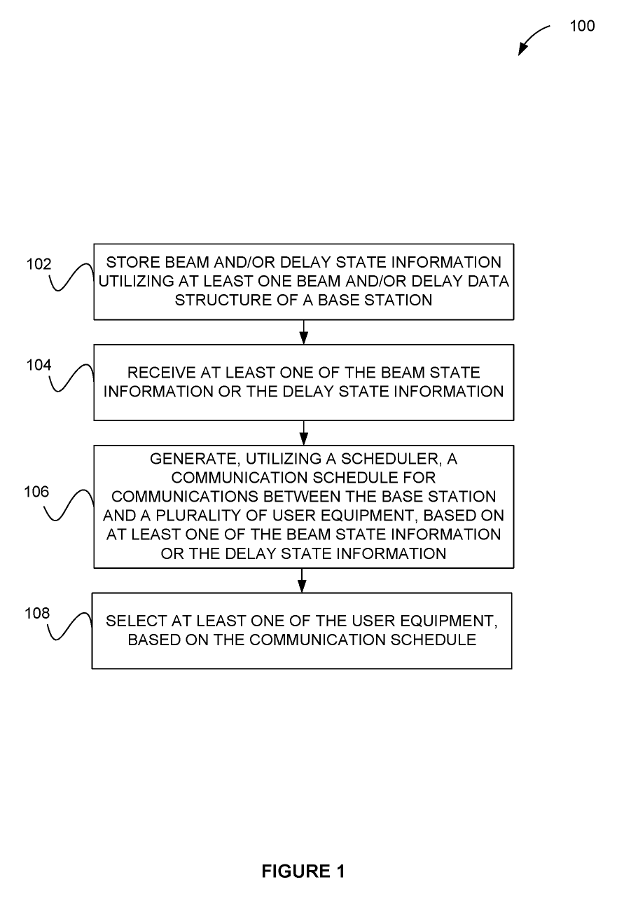

FIG. 1 illustrates a method 100 for selecting user equipment (UE) based on beam or delay state information, in accordance with one embodiment. In the context of the present description, the aforementioned base station may include any node configured for cooperating with other base stations to afford a wireless network. Non-limiting examples of such base station may include a Node B, multi-standard radio (MSR) radio node such as an MSR BS, eNode B, network controller, radio network controller (RNC), base station controller (BSC), relay, donor node controlling relay, base transceiver station (BTS), access point (AP), transmission point, transmission nodes, remote radio unit (RRU), remote radio head (RRH), node in a distributed antenna system (DAS), cell, and/or any other station that is configured for communicating with a UE.

Still yet, the aforementioned UE may refer to any type of wireless device configured for communicating with a radio network node in a cellular communication system. Non-limiting examples of the UE may include a target device, device to device (D2D) UE, machine type UE, UE capable of machine-to-machine (M2M) communication, personal digital assistant (PDA), iPAD™, tablet, mobile terminal, smart phone, laptop embedded equipped (LEE), laptop mounted equipment (LME), universal serial bus (USB) dongle, and/or and any other type of wireless device configured for communicating with a base station. Even still, the network may refer to any group of base stations that is configured for cooperating using any desired network protocol (e.g. 4G/LTE/LTE-Advanced network protocol standard and/or any other advancement/permutation thereof, etc.).

As shown in operation 102, state information is stored utilizing at least one data structure of a base station. In the context of the present description, the state information may include any data that includes, describes, and/or is derived from a state of at least one aspect (e.g. power, beamforming, delay, etc.) associated with the base station. For example, in one possible embodiment, the state may include parameters of one or more of the aforementioned aspects.

Also in the present description, the data structure may refer to any data, metadata, and/or instructions stored on a non-transitory computer readable medium (examples of which will be described later). In some embodiments that will be described later, the data structure may take the form of a virtual node (e.g. virtual traffic node, etc.).

In some specific embodiments, the at least one data structure may include a beam data structure for storing beam state information, and/or a delay data structure for storing delay state information. Such beam state information stored in the beam data structure may include data associated with any aspect of a beam that is emitted from at least one antenna of the base station. For example, in various embodiments, the data may be associated with a power, width, direction, and/or any other aspect of a main lobe of a signal that is generated by any desired technique (e.g. beamforming, beam switching, weighting, spatial filtering, etc.).

Further, the aforementioned delay state information stored in the delay data structure may include data associated with any aspect of a delay in connection with a communication, signaling, etc. between the base station and the UE. For example, in various embodiments, such data may be associated with a duration, repetitiveness, and/or any other aspect of the aforementioned communication (e.g. data and/or control signaling, etc.) between the base station and the UE. As an option, the at least one data structure may also include a power data structure for storing power state information that may be associated with a level of power that is emitted from the base station and/or UE in connection with communications, etc.

With continuing reference to FIG. 1, at least one of the beam state information or the delay state information is received, in operation 104, from the at least one data structure at a base station scheduler of the base station (hereinafter “scheduler”). In the context of the present description, the scheduler may include any hardware and/or software that is configured to select a UE for the base station to service. Further, the state information may be received by being pushed from the data structure(s) to the scheduler, pulled from the data structure(s) by the scheduler, and/or any desired technique that results in the state information being received.

Next, in operation 106, the base station scheduler is utilized to generate a communication schedule for communications between the base station and a plurality of UE, based on at least one of the beam state information or the delay state information. In the context of the present description, such communication schedule may include any data structure, logic, code, instruction(s), etc. that is capable of being used to select at least one of the UE, as will become apparent.

By this design, at least one UE is selected, in operation 108, based on the communication schedule. It should be noted that such UE selection may be carried out in any desired manner (and for any purpose) that is, at least in part, a function of the communication schedule and, thus, is also a function of at least the beam and/or delay state information from at least one of the respective data structures. Just by way of example, the at least one UE may be selected based on the power state information for controlling a power expended by the base station. Further, at least one UE may be selected based on the beam state information for controlling a flashlight effect in connection with the base station. Still yet, at least one UE may be selected based on the delay state information for controlling a delay in connection with a communication between the base station and the at least one UE. It should be noted that the communication schedule may be generated by the scheduler based on other criteria as well. Just by way of example, the communication schedule may be generated based on at least one of a call priority, a call timing, a call location, or a call quality of service rating.

To this end, in some optional embodiments, one or more of the foregoing features may allow a scheduler to take various parameters (e.g. power, beamforming, delay, etc.) into account when selecting a particular UE to service. This may, in turn, result in more granular network utilization optimization across a more thorough set of parameters that would otherwise be foregone in systems that lack such capabilities. It should be noted that the aforementioned potential advantages are set forth for illustrative purposes only and should not be construed as limiting in any manner.

More illustrative information will now be set forth regarding various optional architectures and uses in which the foregoing method may or may not be implemented, per the desires of the user. For example, in one embodiment, the state information may be communicated from the at least one data structure to the scheduler of the base station, via another scheduler (e.g. a virtual scheduler) that can operate to update the state information, based on one or more constraints. It should be noted that the following information is set forth for illustrative purposes and should not be construed as limiting in any manner. Any of the following features may be optionally incorporated with or without the exclusion of other features described.

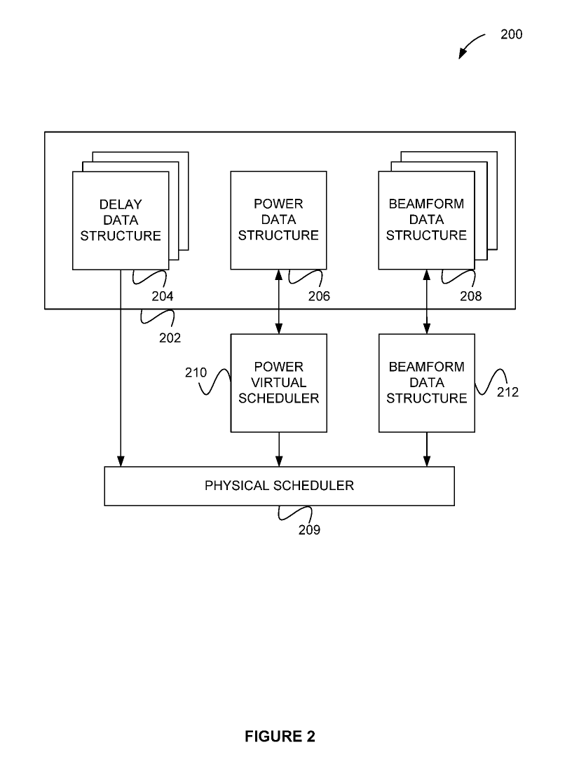

FIG. 2 illustrates a system 200 for selecting a UE based on state information, in accordance with one embodiment. As an option, the system 200 may be implemented in the context of any one or more of the embodiments set forth in any previous and/or subsequent figure(s) and/or description thereof. For example, the system 200 may be configured for carrying out the method 100 of FIG. 1. However, it is to be appreciated that the system 200 may be implemented in the context of any desired environment.

As shown, the system 200 system includes a non-transitory computer readable medium 202 with a plurality of data structures (e.g. virtual traffic nodes, etc.) stored thereon in connection with a base station. It should be noted that the non-transitory computer readable medium 202 may or may not be physically part of the base station. For example, one embodiment is contemplated where the non-transitory computer readable medium 202 is part of the base station, and another embodiment is contemplated where the non-transitory computer readable medium 202 is part of a remote component, but remains accessible by the base station.

With continuing reference to FIG. 2, the plurality of data structures (e.g. virtual traffic nodes, etc.) include at least one delay data structure 204, at least one power data structure 206, and at least one beam data structure 208. In other embodiments, it is contemplated that other data structures may be included that are associated with other aspects of the base station. Further, in one embodiment, only a single power data structure 206 may be provided, while multiple delay data structures 204 exist for each of a number of UEs being serviced or are capable of being serviced. Still yet, multiple of the beam data structures 208 may be provided, one for each of a plurality of interlaces. In one embodiment, six (6) interlaces/beam data structures 208 may be provided.

Also included is a physical scheduler 209 that is capable of receiving the state information directly and/or indirectly from the delay data structure(s) 204, power data structure(s) 206, and beam data structure(s) 208. Further, a plurality of other schedulers may be provided for communicating state information from the respective data structure(s) to the physical scheduler 209, as well as update the state information of the relevant data structures. Specifically, a power virtual scheduler 210 is provided to communicate the power state information from the power data structure(s) 206 to the physical scheduler 209, and a beam virtual scheduler 212 is provided to communicate the beam state information from the beam data structure(s) 206 to the physical scheduler 209. As an option, the physical scheduler 209 may operate utilizing a first clock (not shown) and the virtual schedulers 210, 212 may operate utilizing a second virtual clock (also not shown) that runs at a speed that is a multiple of the first clock (through any sort of divider).

By this design, the physical scheduler 209 is fed the state information (that may, in one embodiment, take the form of various parameters) from the data structures 204, 206, 208 (e.g. virtual traffic nodes, etc.) at a frequency driven by the aforementioned second virtual clock, such that, at another frequency (driven by the first clock), the physical scheduler 209 may make decisions as to which UE should be serviced at a particular time-frequency resource of a communications protocol (e.g. 4G/LTE/LTE-Advanced and/or any permutation thereof, etc.). Further, such physical scheduler decisions may be made more intelligently, using the foregoing state information.

Just by way of example, the physical scheduler 209 may utilize the beam state information for controlling (e.g. mitigating, etc.) a flashlight effect. In one embodiment, the flashlight effect may result from a “flash” of interference (e.g. caused by a downlink transmission involving another UE) being detected by a UE, where such interference results in a report of a lower channel quality indication (CQI) for a time period. In such embodiment, the physical scheduler 209 may use the beam state information to predict whether a flashlight effect will be incurred by the selection of certain UEs, and thus select a UE that avoids, at least in part, such flashlight effect.

As yet another non-limiting example, the physical scheduler 209 may utilize the delay state information to ensure that certain quality of service (QoS) levels are maintained. In such embodiment, the physical scheduler 209 may use the delay state information in a situation where a first UE (that is ready for service) has a larger amount of data queued for communication that would cause a larger delay, and a second UE (that is also ready for service) with a smaller amount of data queued for communication that would case a lesser delay. In such case, the physical scheduler 209 may use the delay state information to determine whether servicing the first UE prior to the second UE would detrimentally affect overall network utilization or QoS level benchmarks, and thus select the most appropriate UE to service, from a delay perspective.

Of course, these examples are set forth for illustrative purposes only and should not be construed as limiting in any manner. More information will now be set forth regarding various features that may or may not be incorporated into the system 200 of FIG. 2.

Specifically, one possible challenge that may be addressed by one embodiment involves providing a unified scheduling framework incorporating diverse traffic flow optimization, namely power, delay and beam optimization. In one embodiment, a greedy primal dual (GDP) algorithm (to be described later in the context of Equation #1) may be used which is asymptotically optimal. Use of a GPD framework may create two types of nodes for each physical node: 1) utility nodes that may maximize commodities generated by control decisions, and 2) traffic nodes that may process and manage queues.

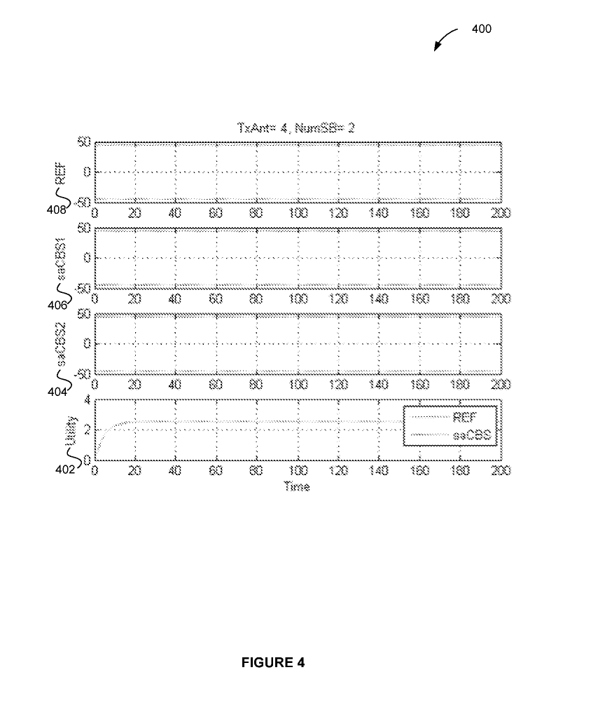

Power, beam (and other parameters, e.g. delay) optimization may be accomplished by adding virtual traffic nodes to a system which may assist in optimizing such parameters. Traffic nodes may accommodate diverse traffic types, including possibly coordinated multi-point (CoMP). Such a GDP algorithm may continuously make control decisions that could maximize the benefits minus the costs of such a decision. Additionally, such a GDP algorithm may be used to optimize a sum of utility nodes commodities minus the sum of traffic nodes costs. For example, a coordinated beam and power switching (CBPS) system with enhanced diverse data applications (eDDA) algorithm may use this framework, which also may not necessarily rely on any a prior system information. Based on plots (e.g. to be described later in the context of FIGS. 4-10), results may exhibit significant gains over an implicit coordinated beam switching (CBS) reference.

In one embodiment, a controlled queuing network may be used as the basis for the GDP algorithm. Such a network may operate and make control decisions in discrete time t=0, 1, 2, . . . . In one embodiment, each network control action may have two effects: 1) the network may include a finite set N^{p} of traffic processing nodes, with queues, and each control action may have an associated queuing control (which may affect traffic (customer) arrival rates to processing nodes, their processing (service) rates, routing between processing nodes, etc.); 2) the network may generate a finite number of commodity (utility) flows, which may form a set N^{u} where each control action k may generate amounts bₙ(k) of the commodities.

Still yet, Xᵢ may be the long-term average rates at which commodities are generated under a given control strategy. However, a dynamic control strategy may be implemented which maximizes a concave utility function U(Xₙ) of average commodity rates, subject to certain constraints, such as that the network remains stable, or power consumption remain bounded. Such a problem may also be rectified asymptotically through use of the GDP algorithm.

In one embodiment, the GDP algorithm may be parsimonious, and naturally may decompose to become a decentralized algorithm when different network elements are capable of independently enacting control decisions. Since both commodity generation and queuing control actions depend on a chosen network control action, use of the GDP algorithm may accommodate scenarios in which choices of commodity generation rates, traffic arrival and service rates, and routing are mutually interdependent in an arbitrary way.

In another embodiment, different commodity types may have different meanings, and some of the commodities may be physical and some virtual. In various embodiments, a commodity may include a traffic flow, which may go through and be processed by the processing network (which may occur by coupling generated commodity amounts and amounts of arrived traffic to one or more nodes). A commodity may also correspond to a monetary award (or penalty), associated with a control action. Still yet, in wireless systems, a commodity may be energy or power consumed by a control action. As such, a commodity may be virtual in that it may serve to keep track of and optimize certain performance measures.

For example, the GPD algorithm may be used to control a queuing network at a lowest average cost (or power consumption), while keeping queues stable. In such an embodiment, the GPD algorithm may create virtual processing nodes, as well. For example, the GPD algorithm may be used to solve optimization problem(s) subject to additional desired constraints on the average commodity generation rates. As such, network control actions which may have a double effect of controlling queues and generating commodities, may allow for the GDP algorithm to accommodate a large variety of applications and scenarios.

Moving on now to the description of a specific possible embodiment, bₙ(k) may include commodity amounts which may be generated by control k. Additionally, drift values ⁻Qₙ(k) may include an expected average (possibly negative) increment, or drift, of the queue length Qₙ at a processing node n, caused by control k. Further, in one embodiment, Qₙ (at all processing nodes) may be large enough for queues to not empty as a result of such control k. Drift values ⁻Qₙ(k) may incorporate the aggregate effect of new arrivals, service, and inter-node routing associated with control k.

The following Equation 1 represents a greedy primal dual (GPD) algorithm, which also may represent control k.

$$k ( t ) = {max}_{k} {\sum }_{i ∈ {N}^{u}} \frac{\partial U}{\partial {X}_{i}} {b}_{i} ( k ) - {\sum }_{i ∈ {N}^{p}} β {{Q}_{i} ( t )}^{-} {Q}_{i} ( t ) \qquad Equation 1$$

where β may include a gradient step size, β>0 may include a typically small parameter, b(k) may include a commodity benefit, Q(t) may include the queue length, ∂U/∂X (k) may include a utility gradient, and k may include optimal selection (i.e. making a control decision may be identical to an optimal selection as the control is to make a selection). X(t) may be the vector of the “current averages” of commodity rates, updated as follows:

Xᵢ(t+1)=Xᵢ(t)+β(bᵢ(k(t))−Xᵢ(t)). Equation 2:

In various embodiment, asymptotic optimality of the GPD algorithm (Equation 1) may be include 1) when parameter β is small, the rescaled trajectories (X(t/β),βQ(t/β));t>0, under GPD algorithm, may be close to trajectories (x(t),q(t)),t>0, of some dynamic system; 2) if network structure and parameters are selected to keep one or more queues stable, then, as t→1, all GPD-trajectories may converge to points (v*,q*) such that U(v) may be the maximum possible value of network utility under the stability constraint; and/or 3) the dynamic system may be “primal-dual” (i.e. the attraction points (v*,q*) may be an optimal solution to an underlying convex optimization problem and its dual—e.g. Lagrange Dual Function).

Additionally, in some embodiments, both traffic sources and network processing nodes may operate (using GPD algorithm) under average “power” (or other “cost”) consumption constraints. The GPD algorithm may further be applied to power usage and traffic rate constraints, as well as accommodates virtual commodities and/or virtual queues. The algorithms may be dynamic and parsimonious (i.e. not require a priori system information by using current system state and current control choices). As a result, GPD algorithm may provide a unified (and optimal) framework as applied to: 1) optimizing utility of the network traffic flows subject to stability and average power usage constraints; 2) ensuring that the network remains stable subject to average power usage constraints; and/or 3) minimizing average power consumption of the network, subject to stability.

In one embodiment, if all processing nodes are removed from the GPD algorithm (Equation 1), such that there may be no stability constraint, the GPD algorithm may reduce to a gradient algorithm which may “greedily” select controls to maximize a drift of utility function U(X(t)) and which may be asymptotically optimal.

In another embodiment, if all commodity flows are removed from the GPD algorithm (Equation 1), such that there may be little or no utility, the GPD algorithm may become a “MaxWeight”-type algorithm which may “greedily” select controls to minimize a Lyapunov function

$${\sum }_{n} ( 1 / 2 ) {Q}_{n}^{2} ( t ) ,$$

and which may increase stability of queuing networks. The GPD algorithm (Equation 1) may “greedily” select controls to maximize an expected drift of the following equation:

$$U ( X ( t ) ) - {\sum }_{n} ( 1 / 2 ) β {Q}_{n}^{2} \qquad Equation 3$$

As such, Equation 3 may represent some type of a combination of the Gradient and MaxWeight algorithms, which may be asymptotically optimal. Such a state (e.g. asymptotically optimal) may be contributed to by the following: 1) for a MaxWeight algorithm, function

$${\sum }_{n} ( 1 / 2 ) {Q}_{n}^{2} ( t )$$

may be a Lyapunov function which may promote stability; 2) for the Gradient algorithm, U(X(t)) may function almost as a Lyapunov function, especially as X(t) approaches a certain region (and convergence to the region may be established). In contrast, an alternative GPD algorithm function

$$U ( X ( t ) ) - {\sum }_{n} ( 1 / 2 ) {Q}_{n}^{2} ( t )$$

may not serve as a Lyapunov function used to ensure convergence at an optimal point. In another embodiment, the utility function U(X) may or may not be concave. In view of such, optimal points (attractors) v* may be non-unique.

Still yet, with reference to Equation 1, the scaling {X(t/β),βQ(t/β)},t>0, which in the limit may lead to GPD-trajectories {x(t),q(t)}, may include space scaling being applied by factor β to queue lengths Q, but not to average rates X. As indicated in Equation 2, such space scaling may ensure that both x(t) and q(t) change on the same scale in space. However, in the special case when there are no utility nodes, the first term under the argument max in Equation 1 may be removed (thereby making parameter β irrelevant), and leading to MaxWeight algorithm, which may be optimal for the purposes of network stability. In other embodiments, the GPD algorithm may use parameter β for the purposes of utility maximization subject to stability. Such may be emphasized in the following equation where, for an algorithm to be close to optimal, controls k(t) may be consistent with the following:

k(t)=argmaxₖ∇U(v*)·b(k)−q*·∇⁻Q(k) Equation 4:

where v* and q* may be optimal solutions to the underlying convex optimization problem and its dual (e.g. Lagrange Dual Function). In one embodiment, a dual may maximize a function subject to one or more constraints. Additionally, dual variables or functions may also be construed as a constraint. In order for βQ(t) to remain close to q* (and X(t) to be close to v*), parameter β may be small. As such, Q(t) may be large (of the order of 1/β), and the increments of βQ(t) may be small. Parameter β may also determine the time scale on which X(t) and βQ(t) approach convergence of optimal values. In one embodiment, convergence time may be of the order 1/β. Therefore, the smaller the β, the more precise the GPD algorithm may function, but at the cost of larger queue lengths and larger convergence times.

In one embodiment, a complex heterogeneous communication network may be modeled. For example, utility nodes nεNᵤ may model network users, each of which may generate data traffic. Processing nodes may model buffers in the network, where data messages are queued (while awaiting service from the network elements, such as communication links, data routers, wireless links, etc.). Additionally, the complexity and heterogeneity of the system may be based on a one or more users' capabilities to inject traffic into the network which may be randomly time-varied and mutually dependent. Additionally, available rates at which data from different buffers can be processed by the network, as well as available routing decisions, may be mutually dependent and randomly time-varied.

Further, a network control algorithm may be used to maximize aggregate utility of generated traffic flows (a function of average traffic rates), subject to the constraint that the network remains stable (i.e. data queues in the buffers do not go to infinity). For example, a set of utility nodes (users, generating nodes) Nᵤ may be broken down into non-intersecting subsets Nᵢ indexed by i. Each subset i may be considered as a (traffic) generating switch, so that Iᵤ is a set of (indices of) such generating switches. The mode mᵢ(t) of switch i may be an independent irreducible aperiodic Markov chain with the finite state space Mᵢ. Each switch iεIᵤ may make control (traffic generation) decisions independently. When the switch mode is mᵢεMᵢ, the available controls kᵢ may form a finite set Kᵢ(mᵢ). If generating switch i chooses control kᵢεKᵢ(mᵢ) at time t, then each node nεNᵢ may generate an amount of data (the number of data bits, or customers) bₙ(kᵢ)>0, and the amounts of data λₙₖ(kᵢ)>0 may be sent to the processing nodes jεNₚ. The system utility function may be represented as U(xₙ), where each xₙ is interpreted as an average (long-term) value of bₙ(kᵢ(t)). As such, a utility function may be as follows:

$$U ( {x}_{1} , … , {x}_{{N}_{u}} ) = {\sum }_{n} U ( {x}_{n} ) \qquad Equation 5$$

As shown in Equation 5, system utility may be the sum of utilities of individual generating switches. The processing nodes may be grouped into independent switches. Additionally, a set of processing nodes (servers, traffic processing nodes) N^{p}, as included in Equation 1, may be broken down into non-intersecting subsets Nⁱ. Each subset i may be considered as a (traffic) processing switch, such that I^{p} may be a set of (indices of) these independent switches. The mode mᵢ(t) of switch iεIₚ may be an independent irreducible aperiodic Markov chain with a finite state space Mᵢ. Each switch iεIₚ may make control (traffic generation) decisions independently. When the switch mode is mᵢεMᵢ, the available controls kᵢ may form a finite set Kᵢ(mᵢ). If processing switch i chooses control kᵢ at time t, then each node nεNᵢ may process (serve) the number μₙ of customers from its queue, and these customers may be independently routed to other processing nodes (including self) with probabilities pₙⱼ(kᵢ), jεNₚ. In some embodiments, the system may be left with probability

$$1 - {\sum }_{j} {p}_{nj} ( {k}_{i} ) .$$

In one embodiment, the GPD algorithm (Equation 1) may allow all switches (generating and processing) to choose controls independently, according to the following Equations 6-8 (among other rules). Additionally, it may be assumed that β>0 may be a small parameter.

For example, control rule for a generating switch iεIᵤ (“Generalized Gradient rule”) may include the following, where at time t a control may be chosen:

$${k}_{i} ( t ) = {argmax}_{k} {\sum }_{n} [ \frac{\partial U}{\partial {X}_{n}} {b}_{n} ( {k}_{i} ) - {\sum }_{j} β {Q}_{j} ( t ) {λ}_{nj} ( {k}_{i} ) ] , \qquad Equation 6$$

where running averages Xₙ(t) may be updated as follows:

Xₙ(t+1=(1−β)Xₙ(t)+βbₙ(kᵢ(t)). Equation 7:

Additionally, in one embodiment, initial values Xₙ(0) may be arbitrary. As such, control rule for a processing switch iεIₚ (“MaxWeight rule”) may include the following, where at time t a control may be chosen:

$${k}_{i} ( t ) = arg {max}_{k} {\sum }_{n}^{ } {Q}_{n} ( t ) {μ}_{n} ( {k}_{i} ) - {\sum }_{j}^{ } {Q}_{j} ( t ) {p}_{nj} ( {k}_{i} ) {μ}_{n} ( {k}_{i} ) . \qquad Equation 8$$

In various embodiments, each generating switch may keep track of Xₙ for nodes for which it is providing service. However, if a switch generates or routes data to processing nodes in other (processing) switches (e.g. Coordinated Multipoint or “CoMP”, etc.), then such a switch may need to be provided queue lengths at those nodes.

In one embodiment, control rules corresponding to Equations 6-8 may be further reduced. For example, if a processing switch does not route served customers to other nodes, its control choice may depend on its own state. Additionally, a traffic source (utility node) n may be independent of other sources (i.e. it may form a switch with utility function U(xₙ)), may be time-varying (i.e. has only one mode), and may have two choices (for any time slot) including to “send” or “not send” a fixed amount of data to a fixed processing node j. In this case, the traffic source may choose to send data in slot t if:

$$\frac{\partial U ( t )}{\partial {X}_{n}} - β {Q}_{j} ( t ) > 0. \qquad Equation 9$$

Still yet, in one embodiment, an additional network control constraint may include restricting the average traffic rates generated by each source nεNᵤ to a lower and upper bound, 0<xₙ^{min}<xₙ^{max}. Additionally, with respect to switches consuming resources (e.g. transmission power), where switch i may choose control ki (e.g. it may use power wᵢ(kᵢ)), average power consumed may be constrained where switch i does not exceed a fixed upper bound wᵢ^{max}>0.

Further, additional constraints may be determined by an additional independent virtual processing node. For example, for every (real) utility node nεNᵤ, independent virtual nodes η(n) and ζ(n) may correspond to an upper bound constraint and a lower bound constraint on the average rate of generated traffic (with i being the switch containing n), as follows:

λ_{η(n)}(k)=λ_{ζ(n)}(ki)=bₙ(kᵢ), Equation 10:

μ_{η(n)}(k)=xₙ^{max}, Equation 11:

λ_{ζ(n)}(k)=xₙ^{min} Equation 12:

μ_{ζ(n)}(k)=μ_{ζ(n)}(kᵢ)=bₙ(ki). Equation 13:

In one embodiment, because nodes η(n) and ζ(n) are virtual, each switch i may maintain and update queue lengths at all such virtual nodes corresponding to the real nodes n associated with the switch. The maximum average power constraints may be dealt with similarly to the maximum average traffic rate constraints. For example, for every switch i, independent virtual node v(i) may include:

λᵥ₍ᵢ₎(k)=λᵥ₍ᵢ₎(kᵢ)=wᵢ(kᵢ), Equation 14:

μᵥ₍ᵢ₎(k)=wᵢ^{max}. Equation 15:

Additionally, each switch i may maintain and update a queue length at the corresponding node v(i). In one embodiment, each virtual queue may remain stable if its corresponding constraint is satisfied. Additionally, all switches (e.g. generating and processing switches, etc.) may choose controls (e.g. Equations 16-20 among others) independently to promote asymptotical optimization of the GPD algorithm (Equation 1).

Control rule for a generating switch iεIᵤ (e.g. at time t), may include:

$${k}^{*} = arg {max}_{k} {\sum }_{n}^{ } [ \frac{\partial U}{\partial {X}_{n}} {b}_{n} ( k ) - {\sum }_{j}^{ } β {Q}_{j} ( t ) {λ}_{nj} ( t ) ] + {\sum }_{n}^{ } β [ {Q}_{ζ ( n )} ( t ) - {Q}_{η ( n )} ( t ) ] {b}_{n} ( k ) - β {w}_{i} ( k ) {Q}_{v ( i )} ( t ) . \qquad Equation 16$$

In one embodiment, averages Xₙ(t) may be updated (as indicated in Equation 7) with arbitrary initial values Xₙ(0). Additionally, virtual queue lengths associated with this switch may be updated as follows:

Q_{η(n)}(t+1)=[Q_{η(n)}(t)−xₙ^{max}]⁺+bₙ(k*), Equation 17:

Q_{ζ(n)}(t+1)=[Q_{ζ(n)}(t)−bₙ(k*)]⁺+xₙ^{min}. Equation 18:

Qᵥ₍ᵢ₎(t+1)=[Qᵥ₍ᵢ₎(t)−wᵢ^{max}]⁺+wᵢ(k*). Equation 19:

where a⁺=max(a,0)

Still yet, control rule for a processing switch iεIₚ (e.g. at time t), may include:

$${k}_{i} ( t ) = arg {max}_{k} {\sum }_{n}^{ } [ {Q}_{n} ( t ) {μ}_{n} ( {k}_{i} ) - {\sum }_{j}^{ } {Q}_{j} ( t ) {p}_{nj} ( {k}_{i} ) ] - {w}_{i} ( {k}_{i} ) {Q}_{v ( i )} ( t ) \qquad Equation 20$$

In one embodiment, virtual queue length Qᵥ₍ᵢ₎(t) may be updated as indicated in Equations 17-19. Moreover, the network may include a non-degeneracy condition with additional average traffic rate and average transmission power constraints. For example, a control policy may provide a negative long-term drift to all processing node queues, while keeping average traffic generation rates between lower and upper bounds, and further while keeping average transmission powers strictly below upper bounds. In another embodiment, a control policy may keep a network stable while keeping average traffic generation rates and average transmission power within predetermined bounds. When such conditions hold, the GPD algorithm (Equation 1) as applied to such a network may be asymptotically optimal.

Further, a network may consist of a single generating switch, with no average power constraints, and which may include utility based scheduling in wireless systems, subject to average rate constraints. The GPD algorithm (Equation 1) as applied to such a network (which may be a control rule for a generating switch, without the sums containing Qⱼ and Qᵥ₍ₙ₎) may be asymptotically optimal.

In various embodiment, Greedy Primal Dual Coordinated Beam and Power switching (gpdCBPS) may aim to optimize beam and power control as well as minimize delay in an LTE network under a unified framework. For example, in a complex heterogeneous communication network, utility nodes nεN^{u} may model network users, each of which may be generating data traffic. Additionally, processing nodes may model buffers in the network, where data messages may be queued while awaiting service from network elements (e.g. such as communication links, data routers, wireless links, etc.). In one embodiment, the complexity and heterogeneity of the system may be based on a one or more users' capabilities to inject traffic into the network which may be randomly time-varied and mutually dependent. Additionally, available rates at which data from different buffers can be processed by the network, as well as available routing decisions, may be mutually dependent and randomly time-varied.

Further, a network control algorithm may be used to maximize aggregate utility of generated traffic flows (a function of average traffic rates), subject to the constraint that the network remains stable (i.e. data queues in the buffers do not go to infinity). For example, a set of utility nodes (users) N^{u} may be broken down into non-intersecting subsets Nⁱ indexed by NBᵢ. Each subset NBᵢ may be considered as a (traffic) generating switch, so that I^{u} is the set of (indices of) such generating switches. If generating switch NBᵢ chooses control kᵢ, then each node nεNⁱ may generate an amount of data (the number of data bits, or customers) where bₙ(kᵢ)>0. The system utility function may include U, where each xₙ may be interpreted as (long-term) average value of bₙ(kᵢ(t)). In one embodiment, the utility function may be as follows:

$$U ( {x}_{1} , … , {x}_{{N}_{u}} ) = {\sum }_{n}^{ } U ( {x}_{n} ) \qquad Equation 21$$

As shown in Equation 21, system utility may be the sum of utilities of individual generating switches. Additional network control constraint may be provided to minimize the average traffic delay. In one embodiment, it may be assumed that delay may be minimized and that queue stability may be ignored. As such, the following network queue may result:

$${}_{}^{-}{Q}{}_{n}^{} ( k ) = \frac{1}{{b}_{n} ( t )} \qquad Equation 22$$

Additionally, Equation 22 may occur in a shortest remaining processing time (SRPT) algorithm, where users are prioritized based on which buffers can be cleared the fastest. In another embodiment, this may be similar in effect to stabilizing network queues where ⁻Qₙ=−bₙ. In either embodiment, both may decrease the penalty as bₙ increases, while the penalty of Qₙ(t)/bₙ(t) may represent the time to clear the buffer, such that shorter clearing times may have a smaller penalty compared to larger clearing times. In various embodiments, a penalty may refer to the subtractive term in Equation 1. In the context of Equation 22, the subtractive part (or penalty) may represent time to clear a buffer. In this manner, users with the biggest time to clear the buffer may have a larger subtractive term (penalty) and therefore have a much lower priority compared to a second user with a smaller time to clear the buffer. In one embodiment, a focus of such a type of scheduler (Shortest Remaining Processing Time, or SRPT) may be to quickly flush out buffers. Additionally, users with the biggest queue may also be served first.

Additionally, with respect to switches consuming resources (e.g. transmission power), where when switch NBᵢ chooses control kᵢ it may use power wᵢ(kᵢ), the average power consumed by switch NBᵢ may be constrained by a fixed upper bound w^{max}>0.

Further, with respect to switches which may consume another resource, including flashlight power, where when switch NBᵢ chooses control kᵢ, it may use a flashlight power of w_{fi}(kᵢ). Such average flashlight power consumed by switch NBᵢ may be constrained by a fixed upper bound w_{fi}^{max}>0.

For each additional constraint, an additional independent virtual processing node where each switch NBᵢ (in the virtual node) may maintain and update the queue lengths at all virtual nodes corresponding to real nodes (users) n corresponding to the virtual nodes. For every switch NBᵢ, independent virtual nodes v(i), and η(i) may include:

⁻Qᵥ₍ᵢ₎(k)=wᵢ, Equation 23:

⁻Q_{η(i)}(k)=w_{fi}(kᵢ) Equation 24:

In one embodiment, each switch i may maintain and update a queue length at a corresponding node v(i). Each virtual queue may remain stable if any corresponding constraint is satisfied. In another embodiment, the GPD algorithm (Equation 1) may allow all switches (generating and processing) to choose controls independently, according to the following Equations 26-29 (among other rules).

For example, control rule for a generating switch NBᵢ, iεI^{u} may include the following, where at time t a control may be chosen:

$${k}^{*} = {max}_{k} {\sum }_{n}^{ } [ \frac{\partial U}{\partial {X}_{n}} {b}_{n} ( k ) - β {Q}_{n} ( t ) {}_{}^{-}{Q}{}_{n}^{} ( k ) - β {Q}_{η ( i )} ( t ) {w}_{fi} ( k ) ] - β {w}_{i} {Q}_{v ( i )} ( t ) . \qquad Equation 25$$

where running averages Xₙ(t) may be updated as follows:

Xₙ(t+1)=(1−β)Xₙ(t)+βbₙ(kᵢ(t)). Equation 26:

Additionally, in one embodiment, initial values Xₙ(0) may be arbitrary. The virtual queue lengths, associated with this switch, may be updated as follows:

Qₙ(t+1)=[Qₙ(t)−bₙ(k*)]⁺, Equation 27:

Q_{η(i)}(t+1)=[Q_{η(i)}(t)−w_{fi}^{max}]^{++w}_{fi}(k*), Equation 28:

Qᵥ₍ᵢ₎(t+1)=[Qᵥ₍ᵢ₎(t)−w^{max}]⁺+wᵢ. Equation 29:

where a⁺=max(a,0)

In various embodiments, the GPD algorithm for this case (i.e. a control rule for a generating switch) may provide an asymptotically optimal policy. Additionally, each generating switch may keep track of Xₙ for nodes for which it is providing service. However, if a switch generates or routes data to processing nodes in other (processing) switches (e.g. CoMP, etc.), then such a switch may need to be provided queue lengths at those nodes.

In the cases of virtual nodes (parameter optimization), such control rules may be further simplified. For example, a utility node (user) n may be independent of other sources (i.e. it may form a switch with utility function U(xₙ)), may not be time-varying, and may have two choices (for any time slot) including to “send” or “not send” a fixed amount of data to a fixed processing node j. In this case, the source may choose to send data in slot t if:

$$\frac{\partial U ( t )}{\partial {X}_{n}} {b}_{n} ( {k}^{*} ) - β {Q}_{nj} ( t ) {λ}_{nj} ( {k}^{*} ) > 0. \qquad Equation 30$$

In one embodiment, Equation 30 may be used as a basis of the virtual scheduler with parameter optimization.

In one embodiment, Equation 30 may be used as a basis of the virtual scheduler with parameter optimization. Further, in an embodiment where a virtual NULL user is added which transmits no bits and whose queue is empty, then Equation 30 may be true for NULL users. As such, the scheduler may select either a real user and transmit real bits, or may select the NULL user and transmit no bits.

Thus, in one embodiment, a selection of the UE may conditionally occur based on a cost associated with the state information. Further, the at least one UE may be selected if the cost associated with the state information results in a positive network utility, and at least one virtual user may be selected if the cost associated with the state information results in a negative network utility.

With reference to Equation 30, physical quantities may be assigned to variables indicated in Equation 30. For example, optimization may be accomplished with two virtual scheduling algorithms corresponding to the two virtual processing nodes in Equation 30. Such virtual scheduling algorithms may be used to continuously set an actual per-interlace precoder and power.

With respect to virtual power scheduler, parameter P_{d},P*/J<P_{d}<P* may be fixed, where P* may represent the total power of an amplifier. In each (virtual) time slot and in each subband j, a NB may serve one of the users i (excluding the NULL user) at power level P_{d} (transmission rate may be Rᵢⱼ, depending on the actually measured SINR of user i), or the NB may select a NULL user (in which case the power used may be 0). In one embodiment, a scheduling strategy may be impemented which, over time, may maximize

$${\sum }_{i}^{ } {U}_{i} ( {X}_{i} ) ,$$

where Xᵢ are users average throughputs, subject to the constraint on the total average power

$${\sum }_{j}^{ } {P}_{j} < {P}^{*} ,$$

where Pⱼ is the average power (per virtual slot) allocated in subband j. With discussed hereinabove, P_{d}=wᵢ and the queue Qᵥ₍ᵢ₎(t) are found in Equation 34. In such an embodiment, for each subband j, the following may be calculated:

$$\begin{matrix}( {dU}_{{i}^{*}} , {i}^{*} ) = {max}_{i} ( \frac{{dU}_{i}}{{dX}_{i}} {R}_{ij} - β {Q}_{v ( i )} ( t ) {w}_{i} ) & Equation 31 \\ {X}_{i} = ( 1 - β ) {X}_{i} & Equation 32 \\ {P}_{j} = ( 1 - β ) {P}_{j} & Equation 33 \\ {Q}_{v ( i )} ( t + 1 ) = {[ {Q}_{v ( i )} ( t ) - {P}_{avg} ]}^{+} & Equation 34\end{matrix}$$

Additionally, if dU_{i*}>0, then state variables may be updated as follows:

X_{i*}=X_{i*}+βR_{i*j} Equation 35:

Pⱼ=Pⱼ+βwᵢ Equation 36:

Qᵥ₍ᵢ₎(t+1)=Qᵥ₍ᵢ₎(t+1)+wᵢ Equation 37:

Pseudo code associated with such a virtual scheduler may include, as follows:

for nv = 1:20

for sb = 1:NumSB

pf_su = (these_su,sb,1)./X(these_su);
[Upf,Ipf]= max(J*pf_su − beta*Z(nb)*Pd);
P(nb,sb) = (1−beta)*P(nb,sb);
X(these_su) = (1−beta)*X(these_su);
Z(nb) = max(Z(nb) − PJ, 0);
ue = these_ue(Ipf);
if (Upf > 0)

Z(nb) = Z(nb) + Pd;
P(nb,sb) = P(nb,sb) + beta*Pd;
X(ue) = X(ue) + beta*J*R(ue,sb);

end

end

end

Additionally, virtual beam schedule may include a matrix of precoders V=[v₀ . . . v₁] where the i^{th} column of V may represent a preferred precoder (precoding matrix indicator, or PMI) vector of UEᵢ. Conversely, in other embodiment, precoder w(τ) may be used in time interlace τ. Additionally, in another embodiment, wⱼ may be often used as a precoder in subband j. With respect to the matrix, a histogram may be built and updated, where the histogram may be of used precoders in each subband. In one embodiment, dissimilarity or an amount of flashlight penalty caused by switching during time interlace τ−1 from precoder w(τ−1) to w(τ) during the next cycle may include:

[symbol]

(τ)=1-|w^{H}(τ−1)w(τ)|² Equation 38:

where, when the same precoder is used, [symbol] (τ)=0, and when a completely orthogonal precoder is used during the next cycle, [symbol] (τ)=1. Thus, in one embodiment, a difference in a flashlight effect may be computed between a plurality of instances of UE selection. Additionally, at least one of the instances of the UE selection may be based on the computed difference in the flashlight effect.

In one embodiment, a precoder grouping state variable φ_{τ} may represent an amount of restriction applied to time interlace τ. In each (virtual) time slot and in each interlace τ, each NB may either serve (transmit to) one of the users i with a preferred PMI (transmission rate may be Rᵢⱼ(τ), depending on the actually measured SINR of user i, and the precoder grouping may be restricted), or may not serve any user at all (in which case the precoder grouping may relax). In such an embodiment, a scheduling strategy may be employed to maximizes the network utility (over time). For example, [symbol] _{iτ} may map to w_{fi}(k), and φ_{τ} may map to queue Q_{η(i)}(t) (found in Equation 34).

For each interlace τ, the following may be calculated:

⁻ [symbol] _{iτ}=|w^{H}(τ−1)vᵢ|² Equation 39:

[symbol]

_{iτ}=1−⁻ [symbol] _{iτ} Equation 40:

$$( {dU}_{{i}^{*}} , {i}^{*} ) = {max}_{i} ( \frac{{dU}_{i}}{{dX}_{i}} {R}_{ij} ( τ ) - {βϕ}_{τ} {ϱ}_{i τ} ) \qquad Equation 41$$

Xᵢ=(1−β)Xᵢ Equation 42:

φ_{τ}=(1−β)φ_{τ} Equation 43:

If dU_{i*}>0, then state variables may be updated as follows:

X_{i*}=X_{i*}+βR_{i*j}(τ)⁻ [symbol] _{i*τ} Equation 44:

φ_{τ}=φ_{τ}+δ⁻ [symbol] _{i*τ} Equation 45:

where δ may be a scaling factor to ensure that

$$\frac{{dU}_{i}}{{dX}_{i}} {R}_{ij} ( τ )$$

and φ_{τ} [symbol] _{iτ} are scaled appropriately. Additionally, at steady state,

$$\frac{{dU}_{i}}{{dX}_{i}} {R}_{ij} ( τ ) \text{\textasciitilde} Load .$$

Pseudo code for such a virtual scheduler may include, as follows:

rho_abs = abs(V_ue′*v_old).\hat{ }2;
rho_pmi = 1 − rho_abs;
rho(these_ue,:) = rho_pmi;
for nv = 1:30

for sb = 1:NumSB

[Upf,Ipf] = max(R(these_ue,sb)./X(these_ue) −

beta*phi(nb,sb)*rho(these_ue,sb));

phi_j(nb,sb) = phi_j(nb,sb)*(1−beta);
X(these_ue) = X(these_ue)*(1−beta);
if (Upf > 0)

| | |
|---|---|
| phi_j(nb,sb) | = phi_j(nb,sb) + |

rho_abs(Ipf,sb)*delta;

X(these_ue(Ipf)) = X(these_ue(Ipf)) +

beta*R(these_ue(Ipf),sb)*rho_abs(Ipf,sb);

end

end

end

In one embodiment, a real scheduler may select a user i* interlace τ based on a modified PF metric, as follows:

$$( {dU}_{{i}^{*}} , {i}^{*} ) = {max}_{i} ( \frac{{dU}_{i}}{{dX}_{i}} {R}_{ij} ( τ ) - {ϕ}_{τ} {ϱ}_{i τ} ) \qquad Equation 46$$

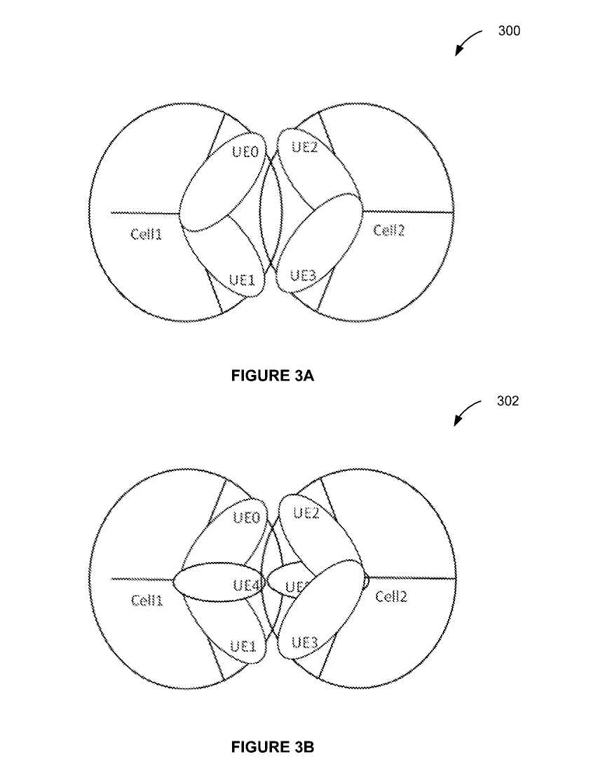

FIG. 3A illustrates a base station scenario 300 including two base stations facing each other each serving two users, in accordance with one embodiment. As an option, the base station scenario 300 may be implemented in the context of any one or more of the embodiments set forth in any previous and/or subsequent figure(s) and/or description thereof. However, it is to be appreciated that the base station scenario 300 may be implemented in the context of any desired environment.

In one embodiment, parameters for use of base station scenario 300 may include:

Layout: 2 Base stations & 57 Base stations

CQI feedback: All SINRâ [symbol] ™s are known perfectly

Antenna Gains: Macro is sectorized (17 dBi)

Antennas (Tx,Rx): update-location-answer (ULA) (2 & 4, 1)

Channel Model: No fast fading

Scheduler: Modified Proportional Fair

Throughput Calculation: log 2(1+SINR),

UEs per Sector: 10

Hybrid automatic repeat request (HARQ) Model: Rachieve=min(Rreport,Rexperienced)

Site to site Distance: 0.5 km

δ:10

FIG. 3B illustrates a base station scenario 302 including two base stations facing each other each serving three users, in accordance with one embodiment. As an option, the base station scenario 302 may be implemented in the context of any one or more of the embodiments set forth in any previous and/or subsequent figure(s) and/or description thereof. However, it is to be appreciated that the base station scenario 302 may be implemented in the context of any desired environment.

FIG. 4 illustrates a plot 400 showing utility progression over time, in accordance with one embodiment. As an option, the plot 400 may be implemented in the context of any one or more of the embodiments set forth in any previous and/or subsequent figure(s) and/or description thereof. However, it is to be appreciated that the plot 400 may be implemented in the context of any desired environment.

As shown, plot 400 includes a utility progression 402 over time for a 4Tx, 2 base station, 4 UE scenario. Additionally, plots 404, 406, and 408 represent an angular direction that the beams are pointed to at each transmission time interval (TTI). Plot 408 represents base station 1 of a reference case, while plots 406 and 404 represent base station 1 and base station 2 respectively for gdpCBPS (beam only). For plots 406 and 404, both reference (REF) and gdpCBPS are identical. As can be observed in plot 402, both the reference and gdpCBPS find and lock onto the optimal interference alignment solution.

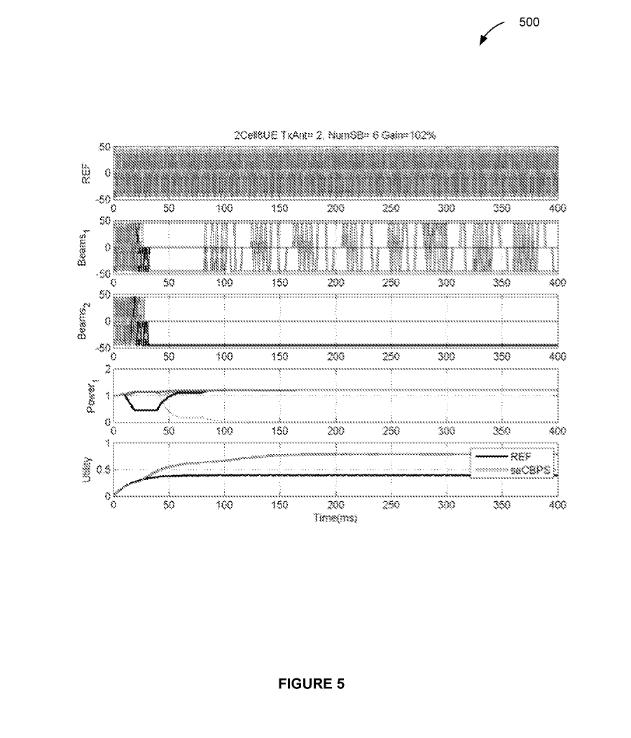

FIG. 5 illustrates a plot 500 showing utility progression over time, in accordance with one embodiment. As an option, the plot 500 may be implemented in the context of any one or more of the embodiments set forth in any previous and/or subsequent figure(s) and/or description thereof. However, it is to be appreciated that the plot 500 may be implemented in the context of any desired environment.

As shown, plot 500 includes a utility progression over time for the 2Tx, 2 base station, 8 UE scenario. As can be observed, the REF can no longer find the optimal solution while gdpCBPS still finds it.

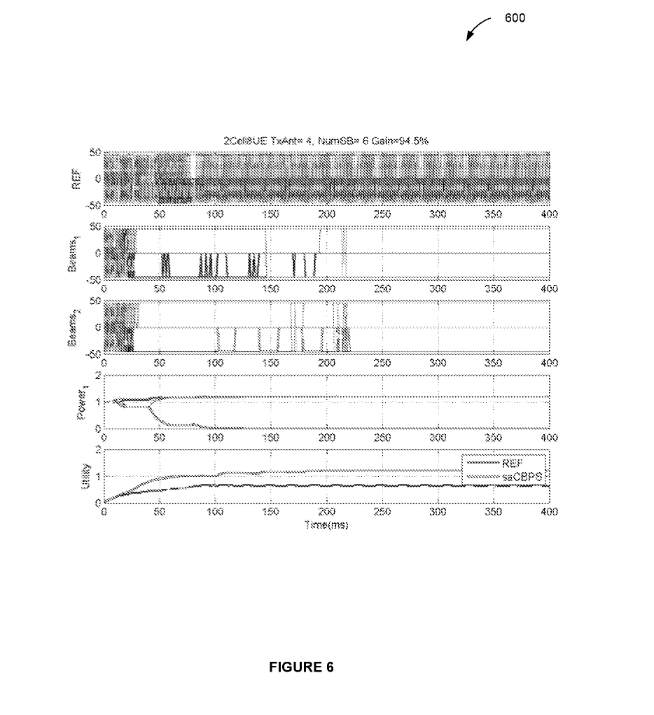

FIG. 6 illustrates a plot 600 showing utility progression over time, in accordance with one embodiment. As an option, the plot 600 may be implemented in the context of any one or more of the embodiments set forth in any previous and/or subsequent figure(s) and/or description thereof. However, it is to be appreciated that the plot 600 may be implemented in the context of any desired environment.

As shown, plot 600 includes a utility progression over time for the 4Tx, 2 base station, 8 UE scenario. As can be observed, the REF can no longer find the optimal solution while gdpCBPS still finds it.

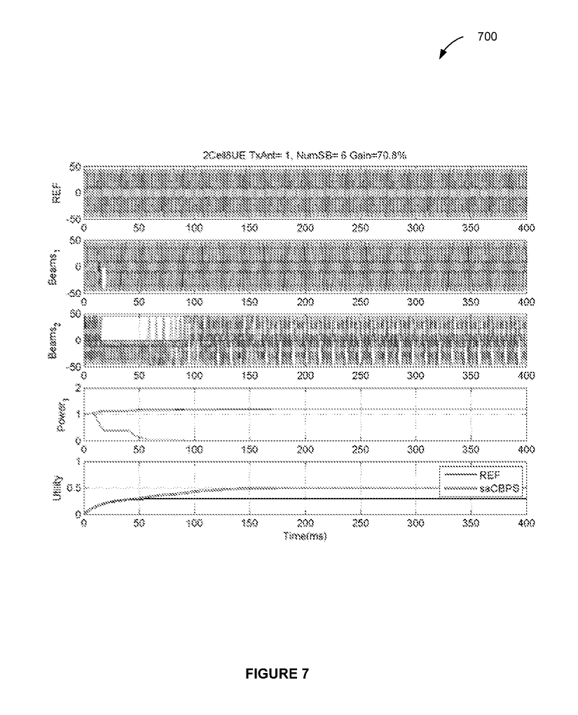

FIG. 7 illustrates a plot 700 showing utility progression over time, in accordance with one embodiment. As an option, the plot 700 may be implemented in the context of any one or more of the embodiments set forth in any previous and/or subsequent figure(s) and/or description thereof. However, it is to be appreciated that the plot 700 may be implemented in the context of any desired environment.

As shown, plot 700 includes a utility progression over time for the 1Tx, 2 Cell, 8 UE scenario. As can be observed, the REF can no longer find the optimal solution while gdpCBPS still finds it.

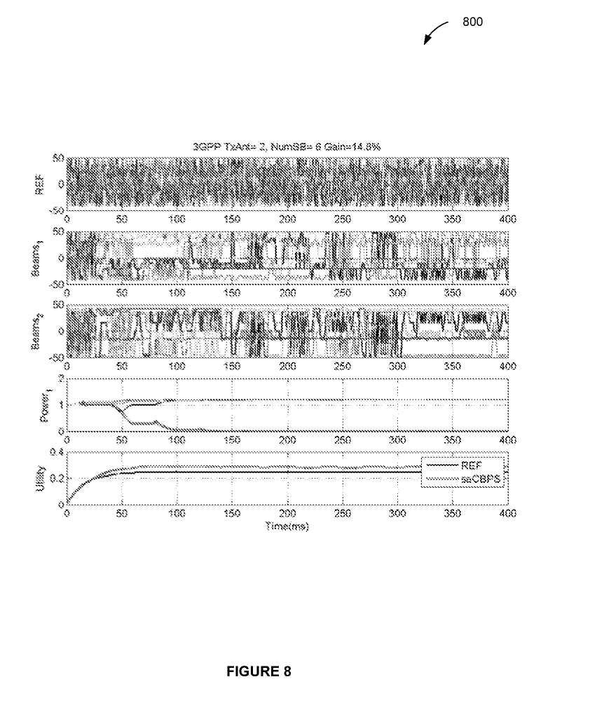

FIG. 8 illustrates a plot 800 showing utility progression over time, in accordance with one embodiment. As an option, the plot 800 may be implemented in the context of any one or more of the embodiments set forth in any previous and/or subsequent figure(s) and/or description thereof. However, it is to be appreciated that the plot 800 may be implemented in the context of any desired environment.

As shown, plot 800 includes a utility progression over time for the 2Tx, 57 Cell, 570 UE scenario. Plot 800 relates to a standard 3GPP 57 base station scenario. As can be observed, although gdpCBPS cannot lock and completely remove the flashlight in this complicated scenario, it does reduce the flashlight significantly.

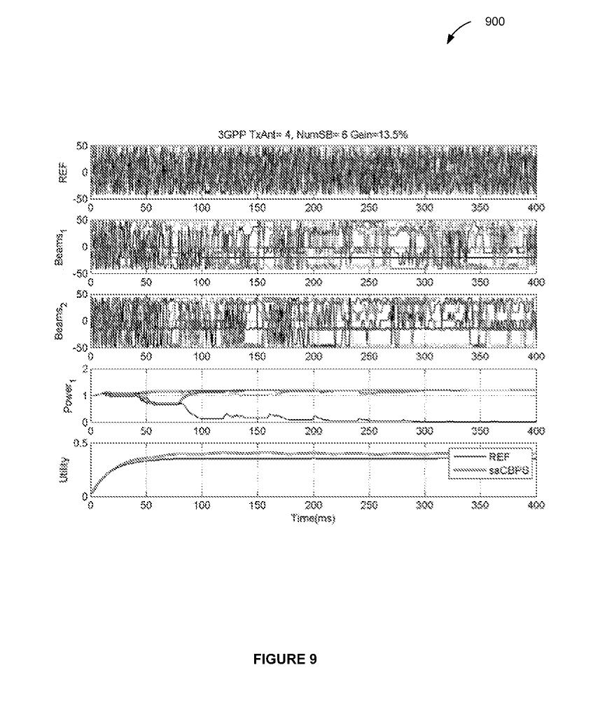

FIG. 9 illustrates a plot 900 showing utility progression over time, in accordance with one embodiment. As an option, the plot 900 may be implemented in the context of any one or more of the embodiments set forth in any previous and/or subsequent figure(s) and/or description thereof. However, it is to be appreciated that the plot 900 may be implemented in the context of any desired environment.

As shown, plot 900 includes a utility progression over time for the 4Tx, 57 Cell, 570 UE scenario. Plot 900 relates to a standard 3GPP 57 base station scenario. As can be observed, although gdpCBPS cannot lock and completely remove the flashlight in this complicated scenario, it does reduce the flashlight significantly.

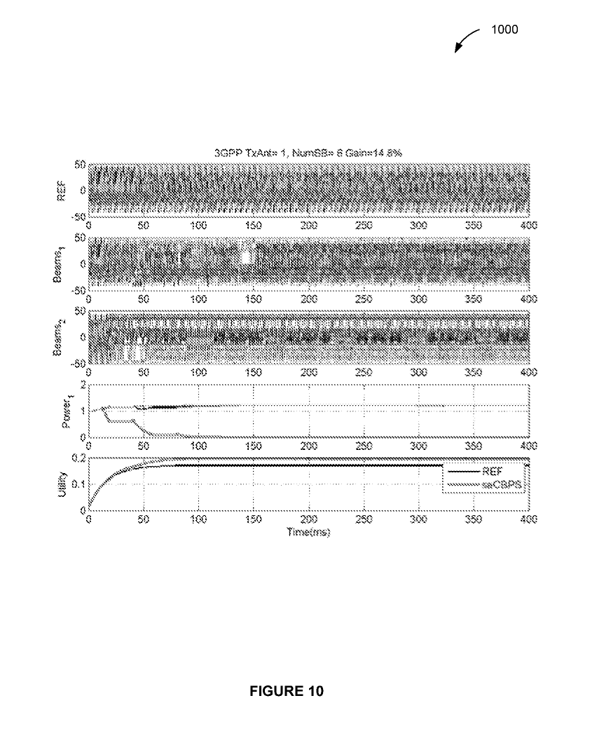

FIG. 10 illustrates a plot 1000 showing utility progression over time, in accordance with one embodiment. As an option, the plot 1000 may be implemented in the context of any one or more of the embodiments set forth in any previous and/or subsequent figure(s) and/or description thereof. However, it is to be appreciated that the plot 1000 may be implemented in the context of any desired environment.

As shown, plot 1000 includes a utility progression over time for 1Tx, 57 Cell, 570 UE scenario (Power only).

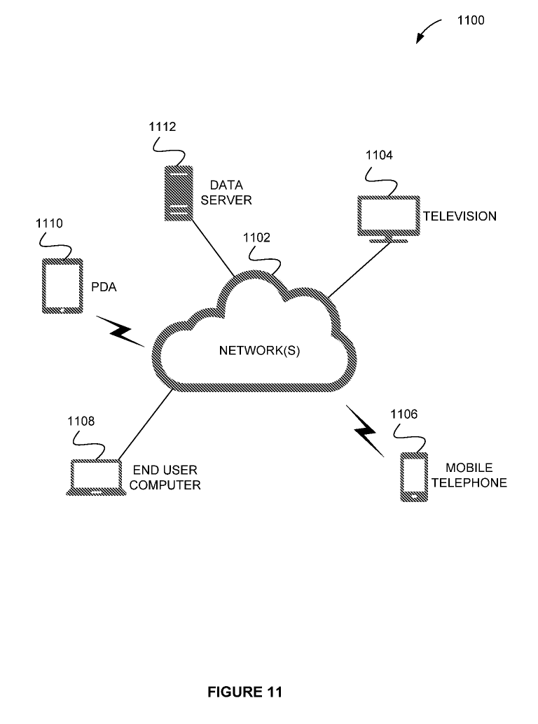

FIG. 11 illustrates a network architecture 1100, in accordance with one embodiment. As shown, at least one network 1102 is provided. In various embodiments, any one or more components/features set forth during the description of any previous figure(s) may be implemented in connection with any one or more of the components of the at least one network 1102.

In the context of the present network architecture 1100, the network 1102 may take any form including, but not limited to a telecommunications network, a local area network (LAN), a wireless network, a wide area network (WAN) such as the Internet, peer-to-peer network, cable network, etc. While only one network is shown, it should be understood that two or more similar or different networks 1102 may be provided.

Coupled to the network 1102 is a plurality of devices. For example, a server computer 1112 and an end user computer 1108 may be coupled to the network 1102 for communication purposes. Such end user computer 1108 may include a desktop computer, lap-top computer, and/or any other type of logic. Still yet, various other devices may be coupled to the network 1102 including a personal digital assistant (PDA) device 1110, a mobile phone device 1106, a television 1104, etc.

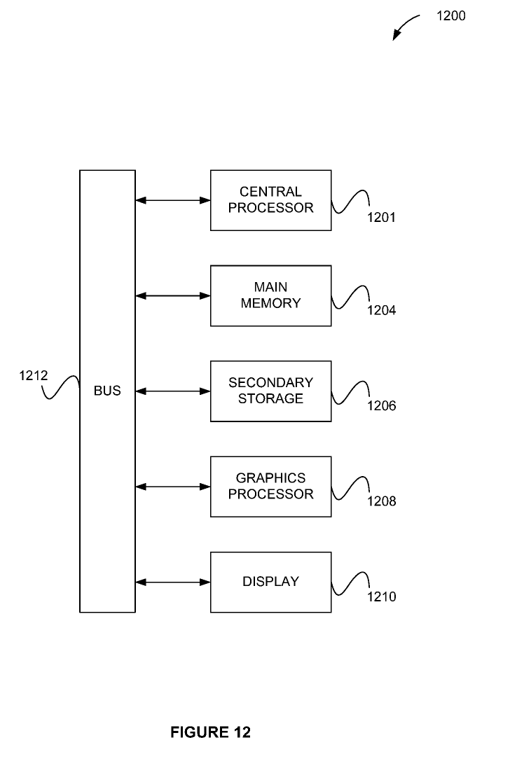

FIG. 12 illustrates an exemplary system 1200, in accordance with one embodiment. As an option, the system 1200 may be implemented in the context of any of the devices of the network architecture 1100 of FIG. 11. However, it is to be appreciated that the system 1200 may be implemented in any desired environment.

As shown, a system 1200 is provided including at least one central processor 1202 which is connected to a bus 1212. The system 1200 also includes main memory 1204 [e.g., hard disk drive, solid state drive, random access memory (RAM), etc.]. The system 1200 also includes a graphics processor 1208 and a display 1210.

The system 1200 may also include a secondary storage 1206. The secondary storage 1206 includes, for example, a hard disk drive and/or a removable storage drive, representing a floppy disk drive, a magnetic tape drive, a compact disk drive, etc. The removable storage drive reads from and/or writes to a removable storage unit in a well-known manner.

Computer programs, or computer control logic algorithms, may be stored in the main memory 1204, the secondary storage 1206, and/or any other memory, for that matter. Such computer programs, when executed, enable the system 1200 to perform various functions (as set forth above, for example). Memory 1204, secondary storage 1206 and/or any other storage are possible examples of non-transitory computer-readable media.

It is noted that the techniques described herein, in an aspect, are embodied in executable instructions stored in a computer readable medium for use by or in connection with an instruction execution machine, apparatus, or device, such as a computer-based or processor-containing machine, apparatus, or device. It will be appreciated by those skilled in the art that for some embodiments, other types of computer readable media are included which may store data that is accessible by a computer, such as magnetic cassettes, flash memory cards, digital video disks, Bernoulli cartridges, random access memory (RAM), read-only memory (ROM), and the like.

As used here, a “computer-readable medium” includes one or more of any suitable media for storing the executable instructions of a computer program such that the instruction execution machine, system, apparatus, or device may read (or fetch) the instructions from the computer readable medium and execute the instructions for carrying out the described methods. Suitable storage formats include one or more of an electronic, magnetic, optical, and electromagnetic format. A non-exhaustive list of conventional exemplary computer readable medium includes: a portable computer diskette; a RAM; a ROM; an erasable programmable read only memory (EPROM or flash memory); optical storage devices, including a portable compact disc (CD), a portable digital video disc (DVD), a high definition DVD (HD-DVD™), a BLU-RAY disc; and the like.

It should be understood that the arrangement of components illustrated in the Figures described are exemplary and that other arrangements are possible. It should also be understood that the various system components (and means) defined by the claims, described below, and illustrated in the various block diagrams represent logical components in some systems configured according to the subject matter disclosed herein.

For example, one or more of these system components (and means) may be realized, in whole or in part, by at least some of the components illustrated in the arrangements illustrated in the described Figures. In addition, while at least one of these components are implemented at least partially as an electronic hardware component, and therefore constitutes a machine, the other components may be implemented in software that when included in an execution environment constitutes a machine, hardware, or a combination of software and hardware.

More particularly, at least one component defined by the claims is implemented at least partially as an electronic hardware component, such as an instruction execution machine (e.g., a processor-based or processor-containing machine) and/or as specialized circuits or circuitry (e.g., discreet logic gates interconnected to perform a specialized function). Other components may be implemented in software, hardware, or a combination of software and hardware. Moreover, some or all of these other components may be combined, some may be omitted altogether, and additional components may be added while still achieving the functionality described herein. Thus, the subject matter described herein may be embodied in many different variations, and all such variations are contemplated to be within the scope of what is claimed.

In the description above, the subject matter is described with reference to acts and symbolic representations of operations that are performed by one or more devices, unless indicated otherwise. As such, it will be understood that such acts and operations, which are at times referred to as being computer-executed, include the manipulation by the processor of data in a structured form. This manipulation transforms the data or maintains it at locations in the memory system of the computer, which reconfigures or otherwise alters the operation of the device in a manner well understood by those skilled in the art. The data is maintained at physical locations of the memory as data structures that have particular properties defined by the format of the data. However, while the subject matter is being described in the foregoing context, it is not meant to be limiting as those of skill in the art will appreciate that various of the acts and operations described hereinafter may also be implemented in hardware.

To facilitate an understanding of the subject matter described herein, many aspects are described in terms of sequences of actions. At least one of these aspects defined by the claims is performed by an electronic hardware component. For example, it will be recognized that the various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar referents in the context of describing the subject matter (particularly in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. Furthermore, the foregoing description is for the purpose of illustration only, and not for the purpose of limitation, as the scope of protection sought is defined by the claims as set forth hereinafter together with any equivalents thereof entitled to. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

The embodiments described herein include the one or more modes known to the inventor for carrying out the claimed subject matter. It is to be appreciated that variations of those embodiments will become apparent to those of ordinary skill in the art upon reading the foregoing description. The inventor expects skilled artisans to employ such variations as appropriate, and the inventor intends for the claimed subject matter to be practiced otherwise than as specifically described herein. Accordingly, this claimed subject matter includes all modifications and equivalents of the subject matter recited in the claims appended hereto as permitted by applicable law. Moreover, any combination of the above-described elements in all possible variations thereof is encompassed unless otherwise indicated herein or otherwise clearly contradicted by context.

What is claimed is:

1. An apparatus, comprising:
at least one base station including at least one data structure including at least one of a beam data structure for storing beam state information, or a delay data structure for storing delay state information, the at least one base station further including a base station scheduler in communication with the at least one data structure, the base station scheduler configured for:
receiving at least one of the beam state information or the delay state information;
generating, utilizing the base station scheduler, a communication schedule for communications between the at least one base station and a plurality of user equipment, based on at least one of the beam state information or the delay state information; and
selecting at least one of the user equipment, based on the communication schedule.

2. The apparatus of claim 1, wherein the at least one base station scheduler further generates the communication schedule based on at least one of a call priority, a call timing, a call location, or a call quality of service rating.

3. The apparatus of claim 1, wherein the apparatus is configured such that the state information is communicated from the at least one data structure to the base station scheduler of the at least one base station, via a virtual scheduler.

4. The apparatus of claim 1, wherein the apparatus is configured such that the at least one data structure of the at least one base station includes the beam data structure for storing beam state information and the delay data structure for storing delay state information.

5. The apparatus of claim 4, wherein the apparatus is configured such that the at least one user equipment is selected based on the beam state information for controlling a flashlight effect in connection with the at least one base station, and the at least one user equipment is selected based on the delay state information for controlling a delay in connection with a communication between the at least one base station and the at least one user equipment.

6. The apparatus of claim 1, wherein the apparatus is configured for computing a difference in a flashlight effect between a plurality of instances of the selecting.

7. The apparatus of claim 6, wherein the apparatus is configured such that at least one of the instances of the selecting is based on the computed difference in the flashlight effect.

8. The apparatus of claim 1, wherein the apparatus is configured such that the selecting conditionally occurs based a cost associated with the state information.

9. The apparatus of claim 8, wherein the apparatus is configured such that the at least one user equipment is selected if the cost associated with the state information results in a positive network utility.

10. The apparatus of claim 8, wherein the apparatus is configured such that at least one virtual user is selected if the cost associated with the state information results in a negative network utility.

11. A method, comprising:
storing state information utilizing at least one data structure of a base station including at least one of a beam data structure for storing beam state information, or a delay data structure for storing delay state information;
receiving at least one of the beam state information or the delay state information;
generating, utilizing a base station scheduler, a communication schedule for communications between the base station and a plurality of user equipment, based on at least one of the beam state information or the delay state information; and
selecting at least one of the user equipment, based on the communication schedule.

12. The method of claim 11, wherein the base station scheduler further generates the communication schedule based on at least one of a call priority, a call timing, a call location, or a call quality of service rating.

13. The method of claim 11, wherein the state information is communicated from the at least one data structure to the base station scheduler of the base station, via a virtual scheduler.

14. The method of claim 11, wherein the at least one data structure of the base station includes the beam data structure for storing beam state information and the delay data structure for storing delay state information.

15. The method of claim 14, wherein the at least one user equipment is selected based on the beam state information for controlling a flashlight effect in connection with the base station, and the at least one user equipment is selected based on the delay state information for controlling a delay in connection with a communication between the base station and the at least one user equipment.

16. The method of claim 11, further comprising:
computing a difference in a flashlight effect between a plurality of instances of the selecting.

17. The method of claim 16, wherein at least one of the instances of the selecting is based on the computed difference in the flashlight effect.

18. The method of claim 11, wherein the selecting conditionally occurs based on a cost associated with the state information.

19. The method of claim 18, wherein the at least one user equipment is selected if the cost associated with the state information results in a positive network utility.

20. The method of claim 18, wherein at least one virtual user is selected if the cost associated with the state information results in a negative network utility.

21. A computer readable media comprising computer executable instructions stored on a non-transitory computer readable medium that, when executed by one or more processors, prompt the one or more processors to:
store state information utilizing at least one data structure of a base station including at least one of a beam data structure for storing beam state information, or a delay data structure for storing delay state information;
receive at least one of the beam state information or the delay state information;
generate, utilizing a base station scheduler, a communication schedule for communications between the base station and a plurality of user equipment, based on at least one of the beam state information or the delay state information; and
select at least one of the user equipment, based on the communication schedule.

22. The computer readable media of claim 21, wherein the computer executable instructions, when executed by one or more processors, prompt the one or more processors to communicate the state information from the at least one data structure to the base station scheduler of the base station, via another scheduler.

23. The computer readable media of claim 22, wherein the base station scheduler includes a physical scheduler.

24. The computer readable media of claim 22, wherein the another scheduler includes a virtual scheduler.

25. The computer readable media of claim 22, wherein the computer executable instructions, when executed by one or more processors, prompt the one or more processors to update the state information utilizing the another scheduler, based on one or more constraints.

26. The computer readable media of claim 21, wherein the state information further includes power state information stored utilizing a power data structure.

27. The computer readable media of claim 26, wherein the computer executable instructions, when executed by one or more processors, prompt the one or more processors to select the at least one user equipment based on the power state information, utilizing the base station scheduler of the base station, for controlling a power expended by the base station.

28. The computer readable media of claim 21, wherein the at least one of the beam data structure for storing beam state information, or the delay data structure for storing delay state information, includes the beam data structure for storing beam state information.

29. The computer readable media of claim 28, wherein the computer executable instructions, when executed by one or more processors, prompt the one or more processors to select the at least one user equipment based on the beam state information, utilizing the base station scheduler of the base station, for controlling a flashlight effect in connection with the base station.

30. The computer readable media of claim 21, wherein the at least one of the beam data structure for storing beam state information, or the delay data structure for storing delay state information, includes the delay data structure for storing delay state information.

31. The computer readable media of claim 30, wherein the computer executable instructions, when executed by one or more processors, prompt the one or more processors to select the at least one user equipment based on the delay state information, utilizing the base station scheduler of the base station, for controlling a delay in connection with a communication between the base station and the at least one user equipment.

32. The computer readable media of claim 21, wherein the at least one of the beam data structure for storing beam state information, or the delay data structure for storing delay state information, includes the beam data structure for storing beam state information and the delay data structure for storing delay state information.

33. The computer readable media of claim 21, wherein the base station scheduler further generates the communication schedule based on at least one of a call priority, a call timing, a call location, or a call quality of service rating.
